(19) United States
(12) Patent Application Publication
(10) Pub. No.: US 2004/0243826 A1
(43) Pub. Date: Dec. 2, 2004

(54) Computer data protection control device

(76) Inventor: Ding-Liang Wang, Sueining City (CN)

Correspondence Address: BIRCH STEWART KOLASCH & BIRCH, PO BOX 747, FALLS CHURCH, VA, 22040-0747, US

(21) Appl. No.: 10/449,076

(22) Filed: Jun. 2, 2003

(51) Int. Cl. H04L 9/00

(52) U.S. Cl. 713/200

(57) ABSTRACT

A computer data protection control device connects to a power supply with back up battery and activates BIOS' and operating system's wake up routines through computer's I/O interface or PC chipset's standby triggering signal to have the charging control circuitry charge the back up battery; at the abnormal power off moment when the computer is under normal or power saving modes, the computer data protection control device can activate the STD control circuitry to have the computer execute STR and/or Auto-STD routines, to store all the data into hard disk drive or CD then turn off and protect the computer safely.

### BACKGROUND OF THE INVENTION

I. Field of the Invention

This invention relates generally to a computer data protection control device and, more specifically, to a protection control circuitry that can activate charging circuitry and STR (suspend to RAM), Auto-STD routines; the present invention connects to a power supply with back up battery and activates the wake-up routine inside the BIOS through I/O interface or PC chipset's standby triggering signal, at the abnormal power off moment to store all the data in the memory and I/O into hard disk drive or CD then shut down the computer.

II. Description of the Prior Art

Heretofore, it is known that there are two kinds of UPS (uninterrupted power supply), as shown in FIG. 5A and FIG. 5B; FIG. 5A is an ATX type power supply (41) to offer power to the computer system (and peripheral devices) (42), an UPS (43) connects to the AC power in parallel and in front of the system, the UPS (43) can offer AC power to the computer power supply (41) when the AC power is out to prevent the malfunction condition. FIG. 5B shows an UPS (44) with Auto-STD function is connected between he power supply (41) and the computer system (and peripheral devices) (42), when the AC power is out, the UPS (44) offers DC back-up power to the computer system (and peripheral devices) (42) to prevent malfunction, at the same time applies the ATX/SPC control signal to activate the Auto-STD system.

The two UPS (43), (44) of the two known computer power supply systems described above are connected in front of or behind the ATX power supply (41), they are independent of the computer system, such mechanism causes extra space needed and extra devices to increase manufacturing cost. In order to save space and cost, most of the UPS only offer limited power that gives only short period of time for users to do data saving or some emergency operations after power is out. The UPS are not applied very often to be a standard computer peripheral; they are not very popular. However, if a UPS is not installed, under abnormal power out condition, computer data in process will be lost, the data have to be keyed in again. The known computer power supply systems need to be improved.

### SUMMARY OF THE INVENTION

It is therefore a primary object of the invention to provide a computer data protection control device to activate the control circuitry of charging function and the control circuitry of the ATX computer system's wake up STR routine, Auto-STD routine, also at abnormal power off time switches DC power to DC back up battery and wake up the computer in STR mode, activate Auto-STD routine to store the data then power off the computer.

It is an objective of this invention to provide a computer data protection control device to offer the function of known UPS and Auto-STD management routine for computer to achieve lower structure cost and space needed.

It is still an objective of this invention to provide a computer data protection control device to give warning sound and light while executes Auto-STD routine to remind users It is still an objective of this invention to provide a computer data protection control device to stores memory and I/O data into hard disk drive or CD, restore all the data, condition back when the power returns, shorten the power on/off time.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a block diagram of the present invention;

FIG. 2 is a function diagram of a protection control circuitry of the present invention;

FIG. 3 is a function diagram of the computer and the protection control circuitry of the present invention;

FIG. 4 is a flow chart of the present invention;

FIG. 5A, 5B are block diagrams of the prior computer power supply systems.

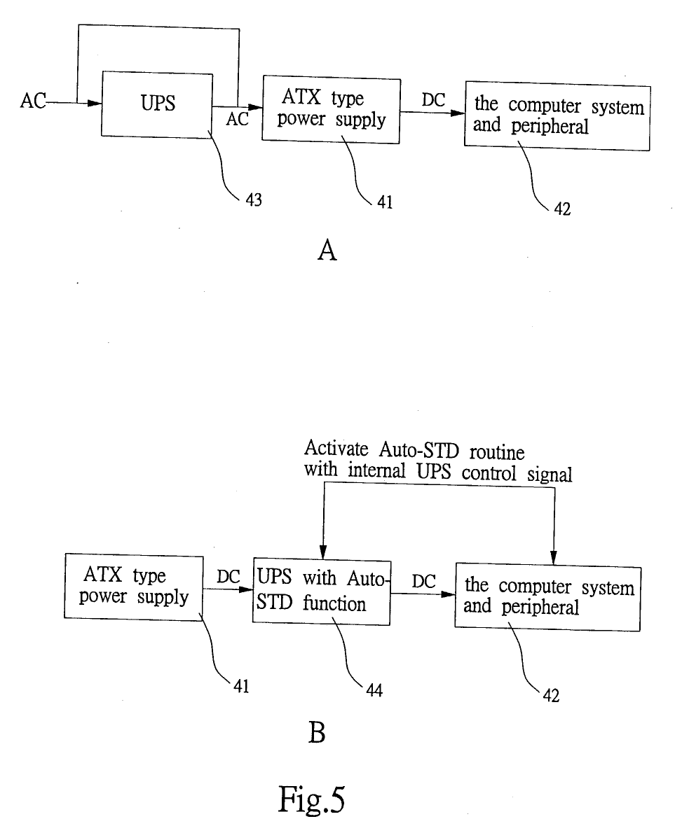

### DESCRIPTION OF THE PREFERRED EMBODIMENT

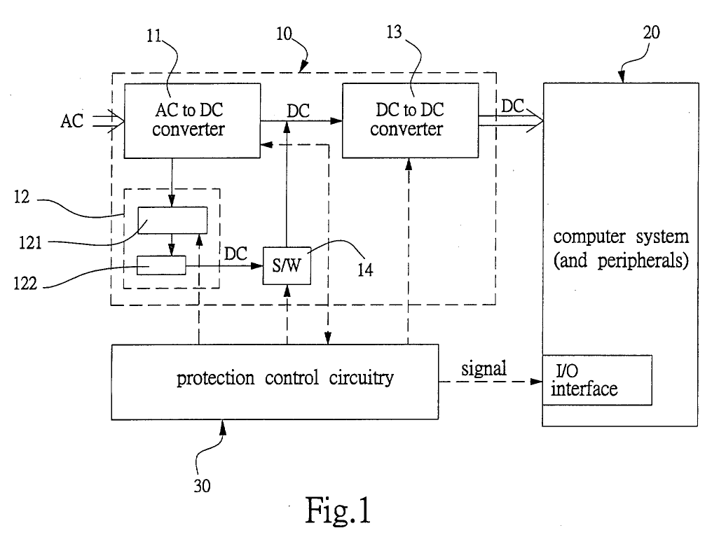

Referring to FIG. 1, the protection control circuitry (30) of the present invention is connected between the power supply (10) the computer system (and peripherals) (20); the power supply (10) consists of an AC to DC converter (11), a rechargeable back-up circuitry (12) and a DC to DC converter (13) to offer power for the computer system (and peripherals) (20). The AC to DC converter (11) connects to AC power outlet and converts the AC power into DC power; the DC power drives the charging circuitry (121) of the rechargeable back-up circuitry (12) to charge the battery (122) and offers power to the DC to DC converter (13), the computer system (and peripherals) (20) and the protection control circuitry (30). The DC to DC converter (13) supplies 5V, 3.3V and 12V different DC voltages to the computer system (and peripherals) (20).

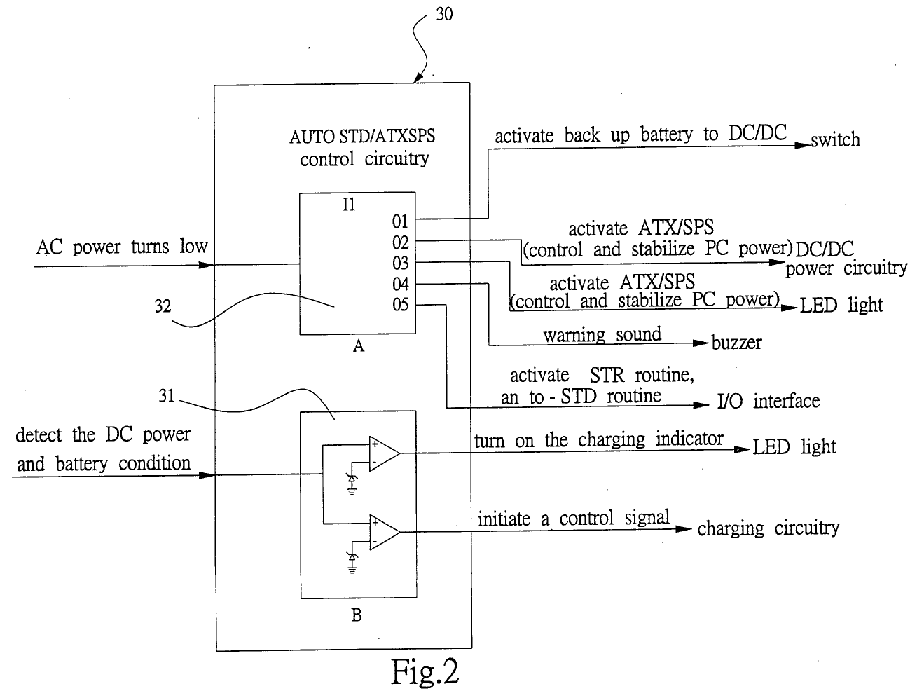

Based on above description and referring to FIG. 1, FIG. 2, the protection control circuitry (30) consists of a charging control circuitry (31) to activate the charging circuitry and an STD control circuitry (32) to activate STR routine and Auto-STD routine. When the AC to DC converter (11) has the AC power input and generates the DC power output, the charging control circuitry (31) detects the battery (122) condition, if battery (122) is in low condition, the charging control circuitry (31) initiates a control signal to the charging circuitry (121) to charge the battery (122) and turn the charging indicator on; when the AC power is out and turns low, the STD control circuitry (32) activates following simultaneously: DC power switching signal, ATX/SPS signal of DC power (control and stabilize DC power), STR routine, Auto-STD routine, activate back-up power indicator and buzzer.

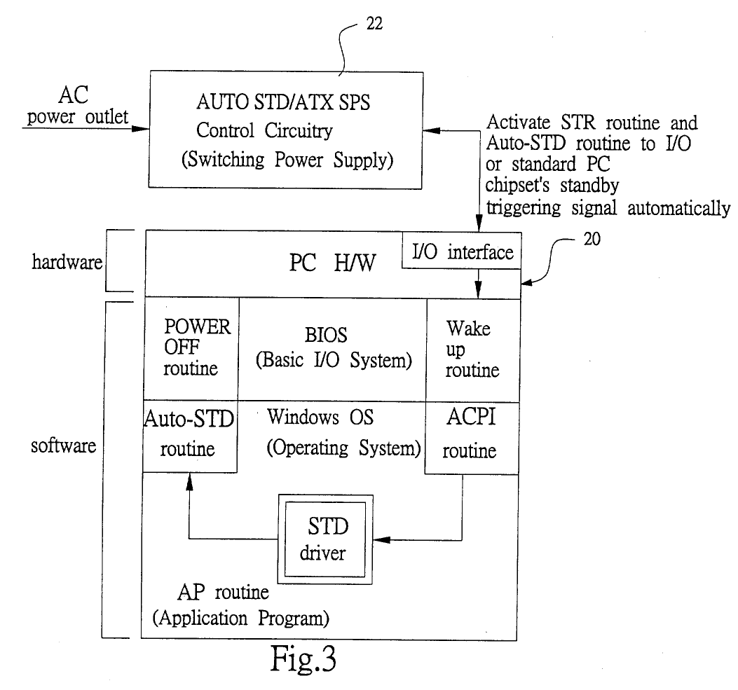

The protection control circuitry (30) described above (as shown in FIG. 2), the STD control circuitry (32) activates STR and Auto-STD routines to pass control signals to computer's I/O interface or standard PC chipset's standby triggering signal to control the computer system (and peripherals) (20), referring to FIG. 3, the present invention can activate PC BIOS' wake up routine to enter the ACPI management routine of Windows system to control and activate peripheral power, included AP's STD driver to start STD routine of Windows system to store data into hard disk drive, then back to PC BIOS to shut down computer and turn the power off.

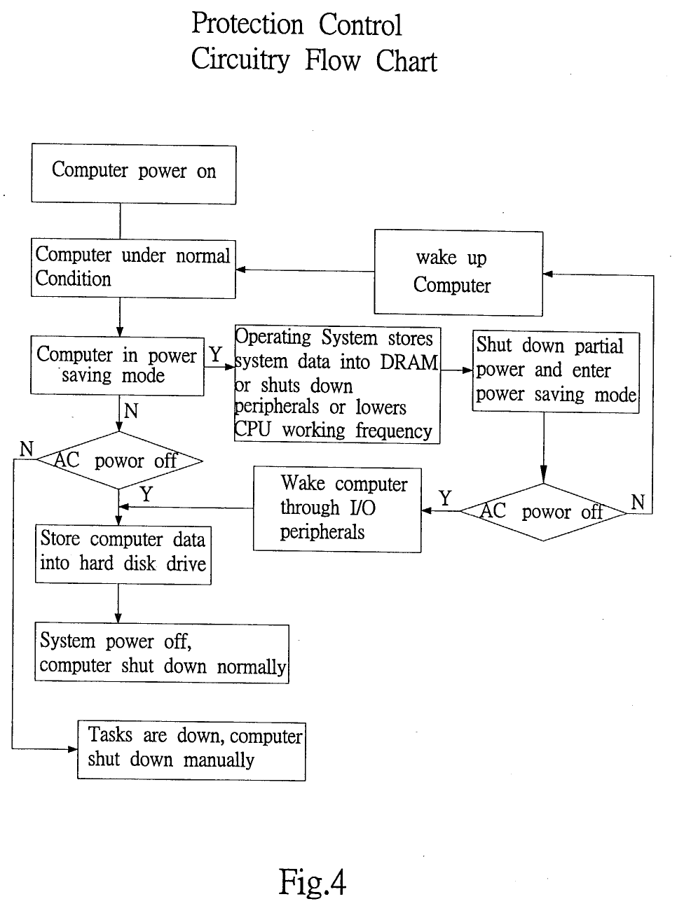

Referring to FIG. 1, FIG. 2 and FIG. 4, when the computer receives abnormal power off signal under normal and power saving mode, the protection control circuitry (30) issues a signal to switch (14) changes the power to battery (122) to offer back-up power, the DC to DC converter (13) supplies power to the computer system (and peripherals) (20) for a short period of time and wake computer if the computer is in power saving mode through I/O interface, then execute auto sleep routine, store all the data in I/O and memory into hard disk drive or CD, finally turn the computer off.

Based on above description, when the computer is running and powered by AC power outlet, the protection control circuitry (30) detects and control to charge back up power; when the computer receives abnormal power off signal under normal and power saving mode, the system can automatically store all the data in I/O and memory into hard disk drive or CD to prevent data loss or system damage by abnormal power off. The function of the back up power is to store data and I/O of the computer system (and peripherals) (20) and execute auto shut down operation, it does not need large quantity of back up power, the charging circuitry and back up battery is simpler and smaller than the known UPS'.

Based on above structure, the protection control circuitry (30) can give warning sound and light while executes Auto-STD routine to remind users; the protection control circuitry (30) stores all the data into hard disk drive, CD under all conditions and restore all the data back when the power is back to normal, such feature enhances Windows system's power management function to shorten power on/off time.

The protection control circuitry (30) has following benefits:

Changes the characteristic of the known computer power supplies and UPS' to make the circuitries simpler and with auto storage function when the AC power is out.

Stores memory and I/O data in stand by mode into hard disk drive or CD safely for a long period of time when the power is off.

Enhances Windows system's power management function to shorten the power on/off time and achieves computer on/off in a very short time.

Applies driver to accept remote site control signals to execute STR routine and Auto-STD routine.

While a preferred embodiment of the invention has been shown and described in detail, it will be readily understood and appreciated that numerous omissions, changes and additions may be made without departing from the spirit and scope of the invention.

What is claimed is:

1. A computer data protection control device comprising:
a protection control circuitry connecting to a power supply with back up battery, said protection control circuitry activates the wake-up routine inside the BIOS, Windows system's wake up routines through I/O interface or PC chipset's standby triggering signal to charge battery when connects to AC power outlet, and activates STR, Auto-STD routines to store data into hard disk drive or CD when the power is abnormally off while computer is in the normal or power saving modes then turns the computer off;
a charging control circuitry detecting the battery condition and activating the charging circuitry;
an STD control circuitry activating STR routine and Auto-STD routine.

2. The computer data protection control device recited in claim 1, wherein said charging control circuitry activates a control signal to a charging circuitry to charge the battery and turn the charging indicator on, when the AC power is out, said STD control circuitry activates following simultaneously: DC power switching signal, ATX/SPS signal of DC power, activate STR routine, Auto-STD routine, back-up power indicator and buzzer.

3. The computer data protection control device recited in claim 2, wherein said STD control circuitry giving warning sound and light while executes Auto-STD routine.
